(19) United States
(12) Patent Application Publication
(10) Pub. No.: US 2014/0008836 A1
(43) Pub. Date: Jan. 9, 2014

(54) Process for Obtaining A Film that Comprises the Incorporation of Natural Antimicrobial Agents in a Polymeric Structure

(71) Applicant: Universidad de Santiago de Chile, Santiago (CL)

(72) Inventors: Abel GUARDA, Santiago (CL); Ximena Valenzuela, Santiago (CL); Alberto Ramirez, Santiago (CL); Maria Jose Galotto, Santiago (CL)

(73) Assignee: Universidad de Santiago de Chile, Santiago (CL)

(21) Appl. No.: 14/026,707

(22) Filed: Sep. 13, 2013

(30) Foreign Application Priority Data
Mar. 14, 2011 (CL) 532-2011

(51) Int. Cl. B29D 7/01

(52) U.S. Cl. CPC B29D 7/01
USPC 264/173.14

(57) ABSTRACT

A process for obtaining a film that comprises the incorporation of natural antimicrobial agents in a polymeric structure for the development of packages designed to increase the shelf life of chilled or refrigerated meat, preferably fresh chilled salmon; said process comprises the following steps:
a) mixing a first extrusion of the antimicrobial active agent with low density polyethylene powder to obtain a pellet;
b) a second extrusion to obtain a film incorporating the pellet obtained in step (a) in a proportion of 10% polyethylene pellets;
c) conduct a three-layer coextrusion to develop the film into which the antimicrobial agent is incorporated, wherein the antimicrobial active agent is incorporated into the film layer which is in direct contact with salmon, where the binder, the middle and the outer structure of the film, provide the requirements for the film structure, without the incorporation of the active agent.

### TECHNICAL FIELD OF THE INVENTION

The present invention relates to a process for obtaining a film that includes the incorporation of natural antimicrobial agents in a polymeric structure for the development of packages designed to increase the shelf life of frozen meat, preferably fresh refrigerated or chilled salmon. In the present invention, the incorporation of the active ingredient is carried out through. a first extrusion process which allows to obtain a pellet (masterbatch) followed, by a second. co-extrusion which. allows the incorporation of the masterbatch into the inner face of the film which is in direct contact with the food.

### BACKGROUND OF THE INVENTION

in recent decades there has been a great technological development in food packaging, to satisfy the demands of consumers, about conservation methods and more natural ways so control the packaging and storage, to ensure quality and safety food. Among the most interesting innovations in this field, are active packaging techniques, with which it is intended that the packaging has an interactive feature, besides being a physical barrier between the product and its environment, building interactions between the container and the benefit of improving food quality, acceptability and safety. European Parliament Regulation CE No. 1935/2004 defines for the first time active packaging materials, such as those intended to extend the shelf life or to maintain or improve the condition. of packaged food, and are designed to deliberately incorporate components that would transmit substances to the packaged food or to the environment surrounding the food or to absorb substances from the packaged food or the environment thereof.

But undoubtedly, active packaging technology that gets the most attention is the antimicrobial active packaging. As is well known, the growth of microorganisms is the main cause of deterioration. of fresh food. The growth of spoilage microorganisms reduces the shelf life of food, while the growth of pathogens endangering health. The use of antimicrobial packaging favors the release of substances that inhibit the growth of microorganisms on the surface of the food. The antimicrobial action in active packaging can be based. on the emission of volatiles to the headspace of the container or the migration of the active component of the packaging material to the surface of the packed food.

In the state at the art, there are several procedures for the incorporation of antimicrobial compounds into a film container. For example document WO 2006/000032 (Milts et al.) Published in Jan. 5, 2006, discloses an antimicrobial packaging material for foods containing 0.05% to 1.5% by weight of a natural essential oil. The oil can be selected from (linalool) linalol and/or methyl chavicol, but also one or more of citral, geraniol, methyl cinnamate, methyl eugenol, 1.8-cineole, trans-α-bergamotene, carvacrol and thymol mixed with one or more polymers selected from copolymers selected from, ethylene vinyl alcohol, polyacrylates, methacrylate copolymers, including methyl acrylate, ethyl ionomers, nylon and other polymers or polymers possessing hydrophilic functional groups, capable of partially anchoring the additives and the mixture of a binder or ligand is coated. on the face of the film contacting the food packaging or is incorporated into a food packaging film. A binding agent such as polyethylene glycol is added to the mixture to improve the retention of volatile oil in the polymer during the process. This material has no regulatory constraints, and the concentrations referred to, do not generate undesirable flavors in the product being packed.

Document WO 2010/006710 (Yildirim et. al.) Published on Jan. 21, 2010, discloses a packing film for producing a container using a substrate of one or more layers and an antimicrobial and/or a functional layer of antifungal applied to the substrate, and forming an outer layer of a packaging film of at least two segments. According to what is reported in that document, the functional layer comprises particles such as antimicrobial agents and/or antifungal active substances.

The document WO 2010/057658 (Del Nobile et al.) Published on May 27, 2010, discloses a method for producing a film of thermoplastic material, particularly of low density polyethylene, incorporating substances with antimicrobial activity, comprising the steps of:
a) Mixture at a temperature exceeding 160° C., a thermoplastic polymer which has a melting point exceeding 160° C. and at least one substance with antimicrobial activity selected from the group consisting of lysozyme, thymol and lemon extract
b) Subjecting the mixture obtained in step a) to a compression at the same temperature as indicated above,
c) Cooled under compression to a temperature exceeding 40° C., resulting in strips, which are divided into short pieces;
d) Feed short pieces into an extruder equipped with a matrix or nozzle, and heating means for the operating temperature is within a value less than or equal to, 160° C., and
e) Make a film extrusion through the matrix.

The three documents described above, report the process of incorporating antimicrobial agents into a plastic film. However, the present invention proposes the incorporation of antimicrobial agents in a much simpler way than the ways disclosed in the prior art.

### SUMMARY OF THE INVENTION

For the salmon marketed as fresh and refrigerated, its main cause and mechanism for deterioration is the growth of microorganisms on its surface, this being the main cause of its short life.

There is a possibility or using volatile natural compounds with antimicrobial properties that can be incorporated into the package, but it is necessary to determine the appropriate mechanism for incorporating these agents in the plastic structure so as to exert its function.

directly on the food surface, maintaining this function during the time the product will be packed and stored.

The present invention relates to processes for obtaining a film that includes the incorporation of natural antimicrobial agents in a polymeric structure for the development of packages designed to increase the shelf life of refrigerated meat, preferably fresh refrigerated salmon.

The active agent with antimicrobial activity, is incorporated by a double extrusion process of the polymer material. The first extrusion yields a pellet (masterbatch) which is obtained by extruding a mixture of the active agent with low density polyethylene powder, and a second extrusion the film is obtained incorporating the masterbatch in an appropriate proportion of polyethylene pellets.

The film which will be used to obtain the packing bag is obtained by a coextrusion process. The material has three layers, where only the inner layer in direct contact with the salmon, and is where the masterbatch containing the active compound, is added.

Therefore, the main objective of the present invention is to provide a system incorporating natural antimicrobial agents in a polymeric structure for the development of packages destined to increase the shelf life of refrigerated fresh salmon.

### BRIEF DESCRIPTION OF THE DRAWINGS

The accompanying drawings are included to provide a better understanding of the invention.

FIG. 1 shows a diagram. of the multilayer structure of the film developed.

FIG. 2 shows a graph of counts in time, mesophilic aerobes (RAM) at various temperatures (° C.) in a. packed product with the antimicrobial package and the same product packed in a traditional plastic without antimicrobial agents (control container).

FIG. 3 shows a graph of counting time of psychrophilus microorganisms at different temperatures (° C. degrees centigrade) in a packed product with antimicrobial packaging and the same product packed With traditional plastic packaging without antimicrobial agents (control container).

FIG. 4 shows a graph of counting time, pseudomonas at 4° C., in a packaged product with antimicrobial packaging and the same product packed with traditional plastic packaging without antimicrobial agents (control container).

FIG. 5 shows a logarithmic graph of the life of the film with the natural antimicrobial agent, with reference to storage temperature.

FIG. 6 shows a graph of the life of the film with the natural antimicrobial agent, with reference to storage temperature.

### DESCRIPTION OF THE INVENTION

The present invention relates to processes obtaining a film that includes the incorporation of natural antimicrobial agents in a polymeric structure, for the development. of packages designed. to increase the shelf life of refrigerated meat, preferably fresh chilled salmon.

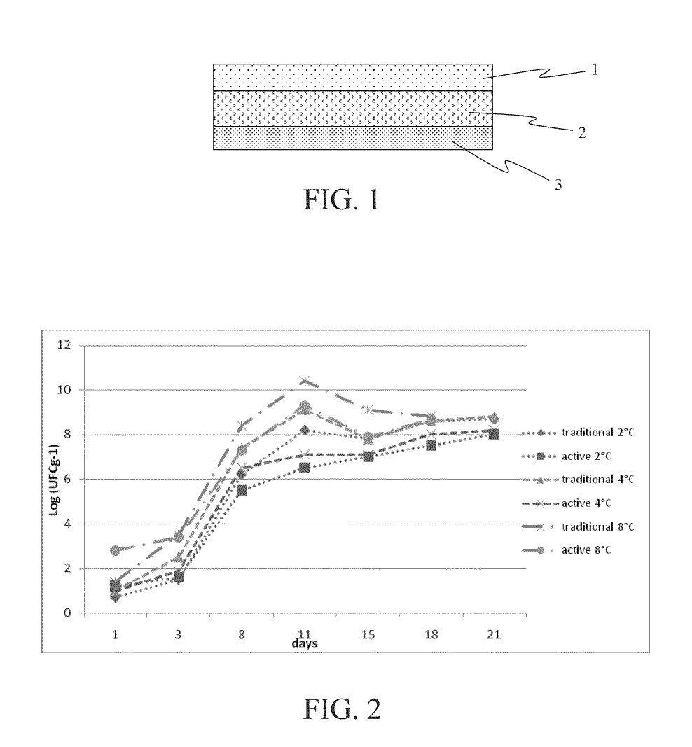

In a first extrusion a pellet (masterbatch) is obtained by extruding a mixture of active agent with low density polyethylene powder, and in a second extrusion the film incorporating the masterbatch in the ratio of 10% polyethylene pellets is obtained. The incorporation of natural antimicrobial was made using a mix (in a pants-type mixer-blender) after the antimicrobial agent. with the powder for the preparation of the corresponding Masterbatch. The development of the film on which the antimicrobial agent was incorporated, was carried out in a three-layer flat head co-extruder (cast). In this case we optimized the incorporation to the active agent, so that only the active agent incorporated in the layer of film which will later be the inner face of the container and therefore in direct. contact. with the salmon, while the intermediate and outer layers, provide the other requirements of the film structure and do not require the incorporation of the active agent. According no what is shown in FIG. 1, the developed structure therefore includes an outer layer (1) of LDPE with a final thickness of 8 microns, which represents 25% of the total thickness of the film, a second intermediate layer (2) 15 microns thick, and represents 50% of the film, consisting of LDPE, and a third inner layer (3), consisting of 90% LDPE and 10% of the active agent.

### i) Masterbatch Preparation

The masterbatch preparation was made with thymol as an antimicrobial agent, thymol powder mixture at different concentrations (2. 8%, 5%, 10% and 15%), with linear low density polyethylene powder and extruded to obtain the masterbatch. The extrusion temperature was about 170° C. (in the head and other parts of the screw).

ii) Production of Natural Antimicrobial Film with Direct Extrusion

The masterbatch containing 10% antimicrobial agent, mixed with LDPE at different concentrations in a masterbatch extruder with concentrations between. 0.5 and 15%.

iii) Determination of the Quantity of Effective Natural AM in Films after the Extrusion Process.

To determine the quantity of natural AM remaining in the films after the extrusion Process, the final concentration was determined by solvent extraction from the plastic. This extraction was performed and subsequent quantification by HPLC (Shimatzu brand) with UV detection. Determined that the loss of antimicrobial extrusion varies between 80 and 90%

### iv) Determination of Antimicrobial Capacity of Films

The antimicrobial effectiveness of the films, was evaluated according to ASTM E-2149, which quantifies the rate of microbial reduction caused by the material under study against a control reference. The antimicrobial capacity of the different films was determined against target microorganisms which. were Listeria innocua as a representative of the microorganisms (Gram+) and Escherichia coli as a representative of the microorganisms (Gram−). Table 1 shows the antimicrobial capacity of the developed films, observing that after 24 hours a reduction of 100% of E. coli is produced, provided that the nominal concentration of antimicrobial in the film is more than 10%, which represents a real concentration in the film of approximately 0.72%. Similar results were obtained for the case of L. innocua, although this case requires a final effective concentration in the film of only 0.46% (Table 3).

TABLE 3
Microbian reduction against E. Coli and L. innocua after 3 and 24 hours.

| Nominal | | | | Reduce | Reduce |
|---|---|---|---|---|---|
| con- | Real | Reduce. | Reduce | 3 Hours | 24 hrs |
| centration | Concentration | 3 Hours | 24 Hours | (L innoc) | (L innoc) |
| (%) | (%) | (E Coli) | (E Coli) | % | % |
| 2.8 | 0.18 | 0 | 0 | 0 | 0 |
| 5 | 0.46 | 0 | 0 | 0 | 99.7 |
| 10 | 0.72 | 0 | 100 | 0 | 99.5 |
| 15 | 0.8 | 0 | 100 | 0 | 99.8 |

### Determination of the Quality of Packed Fresh Salmon in an Antimicrobial Active Packaging Bag.

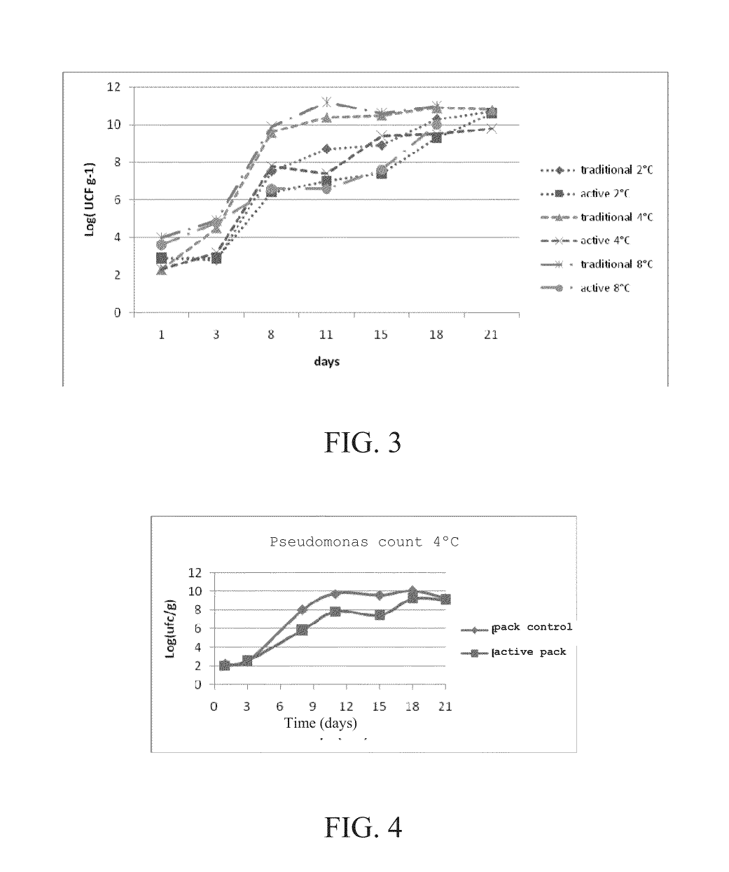

The purpose of this analysis is the evaluation of the presence of microorganisms which deteriorate the fresh salmon meat, for this purpose samples were stored. under temperatures of 2,4,8 and 10 degrees centigrade for 21 days, samples were analysed after 1,3,8,11,15,18 and 21 days of storage. With reference to the microorganisms, it was determined: a count. of aerobic mesofiles, (RAM) pscofils count and also of pseudomonas (FIGS. 2 to 4).

According to the Food Health. Regulations aerobic mesofiles cannot exceed the United Nations Maximum of 10̂6 (cfu/g), which is a 6. Log (cfu/g) in agreement with this paragraph useful lives regulation temperature refrigeration are the following:

| Temperature | VU pack control | VU active pack |
|---|---|---|
| 2° C. | 7.6 days | 9.4 days |
| 4° C. | 6.4 days | 8.0 days |
| 8° C. | 5.4 days | 6.4 days |
| 10° C. | 4.4 days | 5.6 days |

In parallel, the determination of the chemical characteristics of the packaged. product (not volatile bases nitrogen) was analyzed.

In order to perform this analysis, samples were stored. at temperatures 2, 4, 8 and 10° C., and samples were taken and analyzed after 1, 3, 8, 11, 15, 18, 21 days of storage. With obtained data curves were plotted, when the compound BNVT is expressed in mg/100 g in time. The amount of 30 mg BNVT/100 g was used up to (where the useful life is used up). Regarding BNVT analysis as it can be seen, there is a difference between samples packaged with control (traditional packaging) and active packaging, having the antimicrobial active packaging a longer shelf-life than the control packaging, being this difference higher as lower is the temperature.

| Control packing | | ACTIVE PACKING | |
|---|---|---|---|
| Time (BNVT Max) | Temp C.° | Time (BNVT MAX) | Temp C.° |
| 19.81 | 2 | 23.81 | 2 |
| 13.08 | 4 | 17.05 | 4 |
| 8.74 | 8 | 10.60 | 8 |
| 6.35 | 10 | 7.76 | 10 |

Sensorial analysis were carried out with samples that were stored at different temperatures, and analysed were also carried out at 2,4,8,10° C. Samples were analyzed after 1,3,8,11,15,18 and 21 days of storage.

### Evaluation Method:

1. Place and conditions: samples were transferred in aseptic bags to a place with enough light, where the assessment was carried out with surgical gloves to avoid cross contamination of samples.
2. Rating: Trained panelists worked in a focus group dynamics, by agreement, selecting the most representative score for each parameter measured. Considering that there are different parameters that have been measured, and the maximum score is 3 per parameter.
3. Scorecard: The score card is suitable for fish in general, and is as follows:

SENSORIAL ANALYSIS

| Parameter | Points 3 | Points 2 | Points 1 | Points 0 |
|---|---|---|---|---|
| General | Acceptable | Normal | Bad | Rejected |
| appearence | | | | |
| Color-skin | Brilliant | Brilliant | Pigments in | Low |
| | Iridescent, | pigmentation | process of | pigmentation |
| | no | not | decolouring, | dull mucous |
| | discolouring, | lustrous, | milky mucous | |
| | transparent | mucous | | |
| | aqueous | slightly | | |
| | mucus | dull | | |
| Color- | Transparent | Velvety, | Slightly dull | Dull |
| flesh | Soft, | pale slight | | |
| | brilliant, no | change in | | |
| | color change | color | | |
| Condition | Firm elastic | Slightly | Flaxid non | Soft, the |
| of the | soft surface | elastic | elastic pale | meat easily |
| meat | | | | comes off |
| | | | | the skin, |
| | | | | floury and a |
| | | | | little |
| | | | | wrinkled |
| Aroma | Sea smell | No sea smell | Slight smell | Decomposed |
| | | or other | of | |
| | | disagreeable | decomposition | |
| | | smell | | |

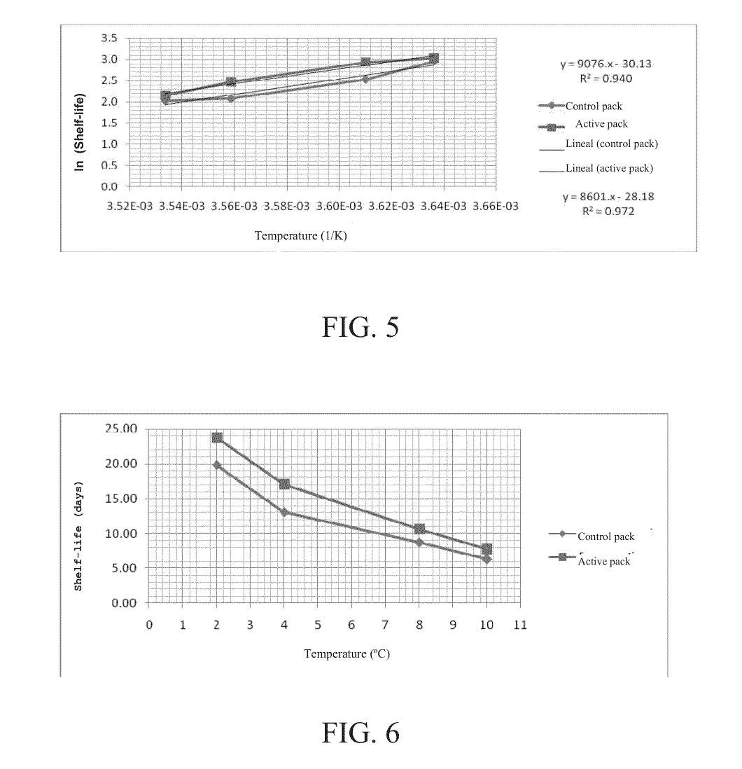

With the results we estimated the shelf-life at different temperatures to which samples were stored, then these results were adjusted to the Arrhenius model to obtain the relationship, in relation to the life span according to the storage, obtaining the results shown in FIGS. 5 and 6.

Arrhenius model, useful life = A * exp (−Ea/R * T)

| | Control packaging | | |
|---|---|---|---|
| | Temp (° C.) | In (Shelf-life) | Shelf-life |
| 19.4 | 2 | 2.87363636 | 17.7 |
| | 3 | 275.405.797 | 15.7 |
| 12.6 | 4 | 263.534.296 | 13.9 |
| | 5 | 251.748.201 | 12.4 |
| | 6 | 240.046.595 | 11.0 |
| | 7 | 228.428.571 | 9.8 |
| 8 | 8 | 216.893.238 | 8.7 |
| | 9 | 205.439.716 | 7.8 |
| 7.6 | 10 | 194.067.138 | 7.0 |

| | ACTIVE PACKING | | | |
|---|---|---|---|---|
| | Temp (° C.) | In (shelf-life) | shelf-life | Active-control |
| 20.6 | 2 | 309.636.364 | 22.1 | 4.4 |
| | 3 | 298.304.348 | 19.7 | 4.0 |
| 18.8 | 4 | 287.054.152 | 17.6 | 3.7 |
| | 5 | 275.884.892 | 15.8 | 3.4 |
| | 6 | 264.795.699 | 14.1 | 3.1 |
| | 7 | 253.785.414 | 12.7 | 2.8 |
| 11.8 | 8 | 242.854.093 | 11.3 | 2.6 |
| | 9 | 2.32 | 10.2 | 2.4 |
| 8.6 | 10 | 221.222.615 | 9.1 | 2.2 |

It can be seen, that the difference in results at the sensory level, that occurs between the active packaging and control packaging, which correlates in a very good way with the results of the chemical analysis shown above, as shown in the chemical results, the difference between the active packaging and packaging control decreases with increase of the temperature. At 2° C. you can see a difference of more than 4 days, which is very significant for the purposes of the project, making possible the extension of the shelf life of the product.

1: A process for obtaining a film that comprises the incorporation of natural antimicrobial agents in polymeric structure for the development of packages designed to increase the shelf life of chilled or refrigerated meat, preferably fresh chilled salmon, CHARACTERIZED in that said process comprises the following steps:
a) mixing a first extrusion of the antimicrobial active agent with low density polyethylene powder to obtain a pellet;
b) a second extrusion to obtain a film incorporating the pellet obtained in step (a) in a proportion of 10% polyethylene pellets;
c) conduct a three-layer coextrusion to develop the film into which the antimicrobial agent is incorporated, wherein the antimicrobial active agent is incorporated into the film layer which is in direct contact with salmon, where the binder, the middle and the outer structure of the film, provide the requirements for the film structure, without the incorporation of the active agent.

2: A process for obtaining a film according to claim 1, CHARACTERIZED in that the antimicrobial agent incorporated in step (a) is thymol.

3: A process for obtaining a film according to claim 1, CHARACTERIZED in that it includes an outer layer of LDPE with a final thickness corresponding to 25% of the total thickness of the film.

4: A process for obtaining a film according to claim 3, CHARACTERIZED in that the intermediate layer with a thickness which represents 50% of the total thickness of the film, and composed of LDPE.

5: A process for obtaining a film according to claim 4, CHARACTERIZED in that the third inner layer is composed of 90% LDPE and 10% with the active agent.

6: A process for obtaining a film according to claim 1, CHARACTERIZED in that the incorporation of an anti-bacterial agent is made by mixing in a pant type mixer homogenizer, after mixing the antimicrobial agent with the powder corresponding to the elaboration of masterbatch.

7: A process for obtaining a. film according to claim 6, CHARACTERIZED in that the masterbatch is prepared with thymol as an active antibacterial agent, wherein the powdered thymol is mixed in a range which varies from 2.8 to 15%, with powdered linear low density polyethylene, extruding the mixture until the masterbatch is obtained.

8: A process for obtaining a film according to claim 7, CHARACTERIZED in that the extrusion temperature is around 170° C.

9: A process for obtaining a film according to claim 1, CHARACTERIZED In that in step (a) the masterbatch has a content of 10% of antimicrobial agent, which is mixed with LDPE in different concentrations comprised between 0.5 and 15% in an extruder.
